(19) United States
(12) Patent Application Publication
(10) Pub. No.: US 2021/0130180 A1
(43) Pub. Date: May 6, 2021

(54) Production & Protection Compositions (PPC)

(71) Applicant: Ali Abdulah Hadia, Mississauga (CA)

(72) Inventor: Ali Abdulah Hadia, Mississauga (CA)

(21) Appl. No.: 15/945,720

(22) Filed: Apr. 4, 2018

Related U.S. Application Data
(60) Provisional application No. 62/482,010, filed on Apr. 5, 2017.

(51) Int. Cl. C01D 3/08; C01D 5/00; C01B 33/14; C01B 25/12

(52) U.S. Cl. CPC C01D 3/08; C01B 25/12; C01B 33/14; C01D 5/00

(57) ABSTRACT

The present invention introduces natural and environmentally acceptable (friendly) chemical compositions for fire-fighting liquids and additives, as well as additives for enhanced oil recovery, oil & gas operation facilities and ships, oil refineries and petrochemical industry, drilling and drilling operations, corrosion protection, de-scaling and scaling prevention, cleaning of raw wool, cotton, textile and fabrics, general industrial cleaning and paint/coating removal, leather, fur and skin industries, sewage and effluent treatment, agriculture, meat, fish and poultry industries, olive oil, vegetable oils, and fruit juice industries, health and beauty and pharmaceutical industries, microbial control and insecticide/biocide, soil remediation, and heat and energy conducting fluids.

### CROSS-REFERENCE TO RELATED APPLICATIONS

This application claims the benefit of U.S. Provisional Patent Application No. 62/482,010 filed Apr. 5, 2017, titled “PRODUCTION & PROTECTION COMPOSITIONS (PPC)”, which provisional application is incorporated by reference herein in its entirety.

### TECHNICAL FIELD

This invention relates to various chemical compositions suitable for various practical industrial and utilitarian uses, and more particularly to such chemical compositions used as solids, aqueous solutions or suspensions.

### SUMMARY OF THE INVENTION

The present invention introduces natural and environmentally acceptable (friendly) chemical compositions for industrial and utilitarian use, as further described below. The chemical constituents of such compositions and mixtures, according to this invention, are simple, widely available, relatively safe to handle, and easily miscible with water to achieve the desired range of useful concentration, according to the specific purpose.

A first preferred embodiment of this invention Is a liquid (code named PPC-U, Production & Protection Compositions) comprising a mixture of chemicals with the following general composition:

| | Concentration range |
|---|---|
| Component | (mg/l, milligrams per litre) |
| Dissolved Sulphate (SO₄) | 550 to 55000 |
| Dissolved Chloride (Cl) | 2200 to 220000 |
| Total Calcium(Ca) | 12 to 1200 |
| Total Magnesium(Mg) | 21 to 2100 |
| Total Potassium (K) | 39 to 3900 |
| Total Sodium (Na) | 1600 to 160000 |
| Water, H₂O | Remaining balance |

A second preferred embodiment of this invention is a solid mixture (code named PPC-L) comprising a mixture of chemicals with the following general composition:

| | | % by weight |
|---|---|---|
| Chemical compound | Name | (range) |
| NaCl | Halite | 8.2 to 99.5 |
| KCl | Sylvite | 0.4 to 40 |
| Ca₅(PO₄)₃(OH) | Hydroxylapatite | 0.5 to 50 |
| K₂Ca₂Mg(SO₄)₄•2H₂O | Polyhalite | 0.4 to 40 |
| MgSiO₃ | Magnesium Silicate | 0.3 to 30 |
| SiO₂ | Silicon Oxide | 0.2 to 20 |
| SiO₂ | Quartz | 0.1 to 10 |

A third preferred embodiment of this invention is a solids-liquid mixture or a suspension (code named PPC-M) comprising a mixture of chemicals of both above mentioned PPC-U and PPC-L with the following general composition:

| Chemical component | % by mass |
|---|---|
| or element | (range) |
| (SO₄)²⁻ | 0.09 to 9 |
| (PO₄)³⁻ | 0.049 to 4.9 |
| Cl | 1.076 to 54 |
| Ca | 0.045 to 4.5 |
| Mg | 0.017 to 1.7 |
| K | 0.049 to 4.9 |
| Na | 0.69 to 69 |
| Water, H₂O | Remaining balance |

A fourth preferred embodiment of this invention is a solid mixture (code named PPC-E) comprising a mixture of chemicals with the following general composition:

| | | % by weight |
|---|---|---|
| Chemical compound | Name | (range) |
| Na₂CO₃ | Natrite | 20-70 |
| Na₂SO₄ | Thernardite | 2-50 |
| Na₅P₃O₁₀ | Sodium Phosphate | 1-30 |
| Na₂SiO₃•5H₂O | Sodium Silicate Hydrate | 0.5-11.5 |
| Na₂S₂O₆•2H₂O | Sodium Sulfate Hydrate | 0.2-4.6 |
| Na₃P₃O₉•3H₂O | Sodium Phosphate Hydrate | 0.1-4 |
| Na₅P₃O₁₀•6H₂O | Sodium Phosphate Hydrate | 0.1-2.5 |
| NaAlSiPO₄•xH₂O | Sodium Aluminum Phosphate | 0.1-4 |
| | Silicate Hydrate | |

As it can be deducted from the above tables, in an alternative preferred embodiment of this invention, PPC-M is prepared by thoroughly mixing PPC-U with PPC-L in the desired ratio. The preferred embodiments of this invention, PPC-M. PPC-U, PPC-L and PPC-E can be prepared starting from individual components or elements, ions, molecules, and/or compounds, by weighing (dosing) the desired amount in a mixing vessel(s), followed by thorough mixing to achieve a homogeneous solution, suspension or solid mixture. Alternative methods of preparation of PPC-M, PPC-U, PPC-L and PPC-E according to this invention may start with pre-existing mixtures of some of the components (for example PPC-E), with only the missing ones being added before use. In alternative embodiments of this invention, the PPC-M mixture of this invention was the original mixture when it was freshly prepared and thoroughly mixed; after such mixture was allowed to settle for some time, the PPC-M mixture settled and divided itself into two phases, namely PPC-U (upper liquid phase) and PPC-L (solids/semi solid lower phase). Moreover, the PPC-E solid phase either can be used as is (solid) or PPC-E can be further mixed with water to obtain different liquid phase compounds, which according to this invention can be used for same purpose as compounds PPC-M, PPC-U, or PPC-I or their respective water based solutions.

For the easy and inexpensive way of preparation of these chemical compositions, it may be noted that one or more components may not have great value among these chemical solutions, and their absence would not affect the performance of this invention. Moreover, it may happen that one or more effective component(s) of these chemicals would have the same effect of this chemical solution (the subject of this invention) with the same effective action with other chemical component(s) or compounds where the effect would come from these components) and/or compounds which are present in this invention.

Furthermore, some of the chemicals (listed above as ingredients of the chemical compositions according to this invention) may be substituted with known chemicals of equivalent properties and still fall within the scope of this invention. All these variations and alternatives should be reserved as an embodiment(s) of this invention and considered as part of the present invention.

Furthermore, due to the fact that these chemical compounds are used in widely diversified industries, alternative embodiments of this invention may include chemical mixtures where concentration of any element, molecule, ion or compound in these chemicals may be greater than or equal to zero in these solutions and less than or equal to 99.99% of the total solution(s) in this invention. This wide range of embodiments will give a wide range of usability to this invention, by rearranging the ratios and weights of various components according to each specific application needs.

Below are some examples of specific exemplary compositions of preferred embodiment of this invention, as analyzed by the inventor; the measured values given below are not for the purpose of limiting or narrowing down the range of embodiments envisioned herein.

Example of a preferred PPC-U composition is depicted in FIG. 1.

Example of preferred PPC-L composition is depicted in FIG. 2.

Example of a preferred PPC-M composition is depicted in FIG. 3.

Example of a preferred PPC-E composition is depicted in FIG. 4.

According to this invention, either one or all of PPC-U, PPC-L PPC-M and/or PPC-E or their mixtures (hereinafter collectively referred to as PPC) have shown surprising utility and advantages for the following industrial and utilitarian applications:

Fire-fighting liquids: PPC-E, PPC-U, PPC-L and/or PPC-M, or their mixes, or mixes of PPC-E, PPC-M, PPC-U and PPC-L, on their own or diluted in water, if so required, (whereby the additional water can be between 0:1 ratio (CONCENTRATE) and 1000,000,000:1 ratio versus PPC), show improved general fire-fighting abilities for most if not all fire classes (according to various fire classifications in different countries), especially when used to extinguish non-polar and polar solvent and fuel fires. According to this invention, the PPC based fire-fighting liquid(s) form(s) a film/coating or barrier on the surface (namely the surface being under fire effect), to isolate the fire from such surface (or to isolate the surface from air that provide oxygen for the fire), or it may act through any other means to assist in extinguishing the fire; such film also acts as a vapor suppressor on the surface, preventing re-ignition of fuel or solvent vapors and/or any other material being under fire. Furthermore, these PPC based fire-fighting solid(s)/liquid(s) can be used for fire prevention, by spraying it/them on any surface at risk of catching fire so as not to allow the fire to start (to protect the fire from happening). For example, these PPC based fire-fighting liquid(s) may be sprayed on tank surface(s), tank top liquid surface, or injected into the tank (while such tanks are full of fuel) to protect the installation (the tank inner surfaces and its fuel content) from catching fire.

Furthermore, if any individual fuel tank (as an example) in a tank farm catches fire and the rest of the nearby tanks become exposed to the risk of catching tire extending from the first burning tank, all tanks exposed to such risk should be treated (sprayed) with PPC-based fire-fighting liquid(s) according to this invention, to prevent them from catching fire by any means (flames from the first tank being blown by the wind, etc.). This example can be extended to any and all solid or liquid installations whether in static condition or moving conditions. These PPC-based fire-fighting liquid(s) according to this invention can be used anywhere and everywhere including, but not limited to all transportations (trucks, automobiles, trains, airplanes, etc.), pipes, pipelines, ships, and all targets exposed to the risk of catching fire.

Enhanced Oil recovery liquids: PPC solids/liquids, or their mixes, alone or mixed (diluted) with additional water (whereby the additional water can be between 1:0 (concentrated) and 1:1,000,000,000 (ppb, parts per billion) PPC versus Water ratio) can be used as enhanced oil recovery liquids for underground oil reservoirs (or for those oil formation just underneath soil/sands cover). When injected down into any reservoir, the effect of such liquid, according to this invention, is to:
Open (expand) the rocks, sands, Soils, clay, calcite, gypsum, and any type of reservoir formation, to make or increase porosity in such reservoir;
Either by itself, or in conjunction with increased porosity, such liquid increases the permeability in reservoir formation to increase the fluid flow (crude, gas, water, their mixes, and all liquids in such reservoir);
It releases additional hydrocarbons from the reservoir formation, to increase production of crude oil, gas, and/or their component and mixtures;
It forms a film on the underground formation surface, preventing any fluid (crude, gas, water, etc.) from adhering to the rocks, sands, soils, calcite, gypsum or any other constituents of the reservoir formation;
The oil recovery liquid injected into the reservoir according to this invention, which comes out as a mixture with the produced fluids (crude oil, gas, water, etc.) shows further positive effects in enhancing the flow in production piping, forming a coating (film) which adheres to the inner surface of pipes, helping the fluid flow faster and with less frictional loss, which saves energy and prolongs life span of such piping, pumps, and all related facilities.

Above ground oil & gas operation facilities: Improvements can be noticed by adding PPC liquids, their mixes, or their water mixes (in any desired mixing ratio) to the fluid side of most operation equipment and facilities, hut we summarize below (as examples, but not limited to) only some of the preferred such applications according to this invention:
When injected into flow lines (from wellhead and downstream), it enhances fluid flow, by preventing crude oils and gases from adhering on inner pipe surfaces, which increase their flow rates and saves energy;
Increases separation of crude and mixed fluids from water and other associated fluids;
Enhances separation of any associated minerals, sands, soils and/or similar impurities;
When added to fluids storage and transporting media (tanks, pipe lines, pipes, ships, etc.), it will protect such fluids/media(s) from catching fire (Fire protection/or prevention);
It can be used to clean all hydrocarbons adhered to the walls of storage tanks, transportation media (pipes, pipelines, shipping tanks, etc.);
It can be used for dewax (dewaxing);
It can be used to clean shipping facilities from all hydrocarbons, including transportation ships;
It can be used to clean pipes and pipelines and similar industrial equipment and services including grounds or floors.

In oil refineries and petrochemical industry: Without limitation, PPC liquids and/or their mixes (and/or their water diluted mixes as desired) can be used and/or added to all process facilities in refineries and petrochemical facilities to either increase production rates and/or save time, money or replace other additives used in these industries; such liquids also enhance the separation of raw or refined products including the used oil recycling, and furthermore, can be used as a general process enhancer in most processes in refineries and petrochemical industries.

Drilling additive and/or drilling operations: PPC liquids (and/or their mixes) can be used as additives for drilling activities.

Corrosion Protection: PPC liquids and/or their mixes exhibit a corrosion-inhibitor activity against metal corrosion (corrosion protection).

Mineral precipitant, de-scaling and scaling prevention: PPC liquids or their mixes can be added to any type of water or other media where mineral, soils, salts or other impurities exists and may cause problems, to eliminate or prevent such problems from occurring, and to help reduce such scaling effects. In general, PPC helps demineralize and precipitate many (if not all) dissolved minerals in any type of water, or any other liquids.

Many industries, without limitation, should benefit from using PPC liquids, but it is expected that the greatest such benefit will be noticed in most (IF NOT ALL) water treatment facilities, including but not limited to: water desalination plants, well plants, injection water in oil and gas, as well as associated water treatment plants in oil and gas industries, sewage treatment plants and any and all types of liquid processing where treatment is required to deal with scaling, minerals, and/or effluent plants.

Ships, sea-going vessels and similar: PPC liquids and/or their mixes can be used in all ships for all relevant applications mentioned in above paragraphs 18 through 26.

Cleaning of raw wool, cotton and fabrics, textile, and any similar applications: PPC liquids or their mixes are effective for cleaning fat, dust and most impurities from raw and fabricated wool, cottons, and alike and for brightening of these products, textiles and fabrics in general terms.

Unlike other known cleaning agents, PPC liquids do not weaken the fiber when cleaned properly, but rather strengthens the cleaned wool, cotton, and all other fabrics and textiles.

When used as wool, cotton and fabric cleaners, PPC liquids or their mixes remove most attached impurities in very simple operation and in all types of water and water temperatures. This will save many (if not all) cleaning steps and reduce the use of process heating in these industries.

Most of PPC or their mixes can be used to treat most (if not all) types of fabrics and leather to prevent fire catching or to slow fire catching or fire speed.

General Industrial Cleaning And Paint/Coating Removal: Aside from the applications mentioned in paragraphs above, PPC liquids or their mixes can be further used as a general industrial cleaning agent in all industries that need to use cleaners; PPC can replace most other cleaners used in such industries and industrial processes equipment.
PPC solids/liquids and/or their mixes remove paints and similar coatings from almost any painted and/or coated material;
PPC liquids and/or their mixes separate and/or isolate between any two media: liquid-liquid, liquid-solids, liquid-air/or gas, solid-solid, and almost any non-identical media, including solids and semi solids in the same media such as in soils, rocks, sands, and alike formations;
PPC liquids and/or their mixes form a separation film between any two medias including air, and around the same media;
PPC solids/liquids and/or their mixes can be used in non-organic oil recycling as well as organic oil recycling processes, including used cooking oil to separate used cooking oil contents and all other impurities. Also, at different concentrations, PPC solids/liquids and/or their mixes can be used to break used cooking oil and other organics associated in the used cooking oils.

In Leather, Fur And Skin industries: In the processing of fresh skins and hides to leather, the use of PPC solids/liquids and/or their mixes can speed up the curing of fresh skins and hides and can therefore reduce process times; PPC may be used as direct replacement for some of products and additives used in most leather/skin and hides and fur processing industries. Also they can be used as skin and hide preservative and to replace most, if not all, other preservatives used for this purpose, including the salts. PPC also eliminates the odor and smell in skin and hide when used for curing/preservation.

In sewage and effluent treatment: PPC liquids or their mixes can be, added to sewage and effluent processes in sewage and effluent treatment plants to break down the organic materials and to separate most (if not all) of their constituents (such as oils, fats, etc.) and may disinfect it at same time. PPC can also be used as additive for sewage and effluent storage and transportation means (tanks, pipes etc.). In these processes and in similar plants wherever odor is an issue, PPC solids/liquids help reduce or eliminate odor and/or to help separate oils/fats.

Use in Agriculture: PPC liquids and/or their mixes can be used in agriculture as follows:
As an insecticide, PPC can be sprayed on the plant leaves, to protect all above ground plants from attacks of insects and alike (used in conjunction with, or as an alternative to, other existing pesticides);
Some of PPC may be added to irrigation water as fertilizers;
PPC can be sprayed on crops, or the harvested products (e.g. flowers, vegetables, fruit, grains, crops, seeds) may be dipped in a concentrated or diluted solution of PPC liquids or their mixes, to prolong their shelf life and, in certain cases, replace or reduce refrigeration needs which saves energy. Furthermore, PPC preserves the valuable moisture content of fruit, vegetables, and similar products in the freezing process. By using PPC liquids, similar moisture content preservations and benefits can be obtained in all frozen food industries process, in general term;
If not mixed with irrigation water, PPC liquids can also be sprayed on soil top underneath irrigated plants and/or trees, to solidify the crust al the surface of the soil, in order to prevent or reduce water evaporation and hence to conserve water and energy and prolong the existence of a moisture environment around irrigated plant/tree roots;
PPC liquids and/or their mixes can also be used by any means, in concentrated form or diluted in water, for processing dry fruits, vegetables, and similar products. Also in these industries, PPC solids/liquids or their mixes can help reduce curing time, preserve goods during drying process, shorten time, and saves or replaces used material and associated costs.

Meat, fish and poultry industries: PPC liquids and/or their mixes can be sprayed on meat fish and/or poultry, or such products can be dipped in a concentrate or dilute solution of PPC liquids or their mixes, to act as a mild preservative, and to keep meat, fish and/or poultry products fresh for a longer time;
PPC can be further used as a defatting agent (to remove or reduce fat from meat, fish, chicken and/or similar products including animals fats in skin and hides as mentioned above;
PPC solution can also be used for processing of dry meats, poultry (if applicable), fish and similar industries. In these industries, PPC help curing and preserve goods during drying process, shorten time, and saves or replaces used material and associated costs.

Olive Oil, vegetable oils, and fruit juice industries: PPC liquids and/or their mixes can be used as extractor agent in the olive oil and vegetable oil industry, fruit juice industry and in any industry that extracts and processes organic oils. PPC, in concentrated form, or mixed with water, is a good extractor agent for olives, vegetables, fruits (specially acidic fruits), etc., efficiently extracting the oil, juice, etc., potentially reducing many processing steps in these industries; notably, PPC used as extractor agent can often work with water at room temperature, without the need for hot water, thus in most cases reducing energy consumption and avoids the resultant increased acidity in olive oil, vegetable oil, and other oils which occurs when using hot water. A further advantage of PPC, when added to the extracted oils (or when used during the process of these oils refining) is that it may reduce the acidity from such oil. In general term in these industries, PPC (as concentrate or diluted in water) helps separate oils from sediments and associated water in cooking oil refining or in the olive oil industries and eliminate the need for hot water use.

Health and beauty and pharmaceutical industries: PPC liquids and/or their mixes can be used as a “fat extractor” in the health and beauty industries, being able to mobilize and extract fat from body, either by applying it directly on the skin or under the skin, or PPC may be added as an additive to existing fat-removing products in the health and beauty market, subject to approvals and certifications; Furthermore PPC can be used in wide range of curing health additive in most (if not all) human and animal skin diseases including but not limited to burns and
PPC is an effective agent for dental cleaning, plaque removal, and/or scale and stain removal. PPC also exhibits a tooth and/or gum protection effects, either alone or as an additive in other protective products;
PPC can also be used as a hair strengthening product, and for hair styling in general, either alone or as an additive to ongoing/or future treatments.

Microbial control and insecticide/biocide: PPC liquids and/or their mixes kill most (if not all) bacteria on contact (or at least works to isolate the bacteria in order either to die or to stop its growth and inactivate it) in any media, whether liquid media or solid surfaces. For this purpose, PPC can be used in all types of industries, including but not limited to oil & gas, water treatment, effluent treatment, sewage treatment, drinking waters, and for disinfecting liquids and surfaces in all industries in general term, where any type of bacteria is present or maybe present; PPC is active against numerous strains of bacteria, including SRB (sulfate reducing bacteria), iron bacteria, and most (if not all) other types of bacteria or microorganisms in all related industries. Furthermore, PPC can be used as a treatment against fungi, algae and the like.

Soil remediation: PPC liquids and/or their mixes can be used to extract hydrocarbon contamination (e.g. crude oil, diesel fuel, etc. or even olive or vegetable oils) from soil. When added as a diluted or concentrated solution to the contaminated soils, PPC helps break down such heavy contaminating compounds and helps separate them from the soil.

As a general isolator and heat and energy conductor: PPC solids/liquids and/or their mixes can be used as general isolator with good heat and energy conduction, as follows:
PPC solids/liquids and/or their mixes can be used in all heat exchangers as corrosion protection, sealing protection, and de-scaling; unlike other isolators, PPC provides very good heat transfer qualities;
PPC solids/liquids and/or their mixes can be used to clean (offline) all electrical and energy related equipment and similar medias, including but not limited to electrical motors, low, medium and high voltage transmission wires and/or cables and all their accessories, while providing excellent conductivity unlike many other types of insulation;
When added to water in open areas, PPC reduce evaporation rates and the loss of water;
PPC liquids and/or their mixes can be used as a general cleaner and/or isolator in all heat transfer systems and energy facilities.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention and within the scope of the claims herewith.

### BRIEF DESCRIPTION OF DRAWINGS

FIG. 1 depicts an example of a preferred PPC-U composition.

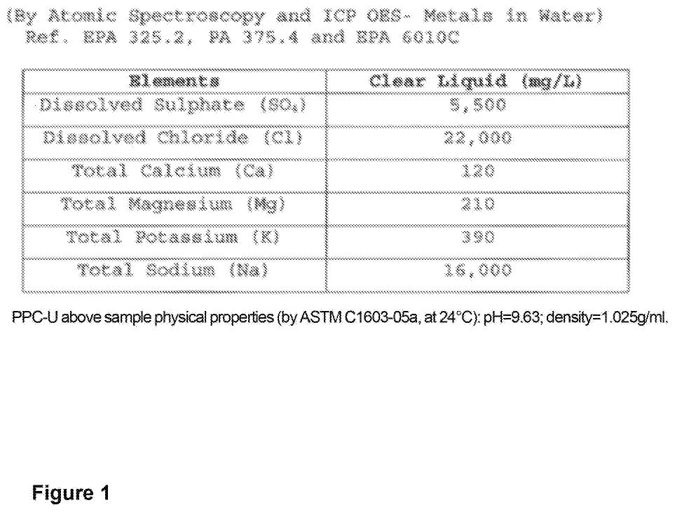

FIG. 2 depicts an example of a preferred PPC-L composition. Comment: The sample generated a moderate to good quality diffractogram, indicating the sample is mainly composed of crystalline compounds. X-ray diffraction analysis shows the crystalline components of the sample consist of about 86% salt, 5% calcium phosphate hydroxide scale, 4% hydrated potassium magnesium sulphate scale, 3% magnesium silicate and 2% silicates. Elemental analysis also suggests the presence of non-crystalline carbon, oxygen, magnesium and Phosphorus bearing compounds. Trace volumes of aluminum, iron and copper bearing compounds were detected during elemental analysis.

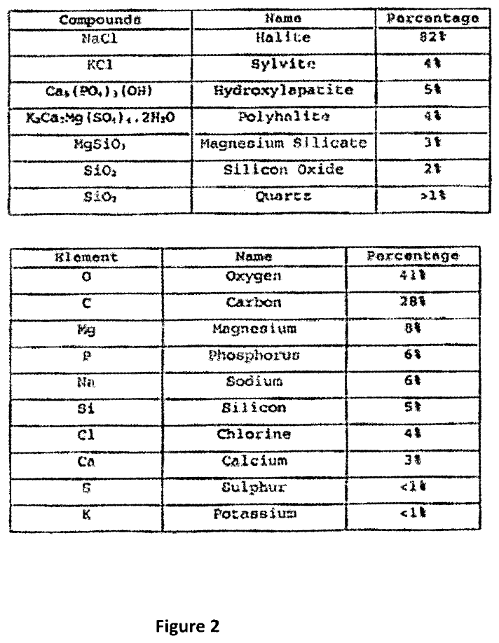

FIG. 3 depicts an example of a preferred PPC-M composition. Notes: total volume of as received suspension sample was 500 ml; total percentage of each element in mixed suspension sample was calculated by total mass (gr) of the elements in Clear liquid phase plus total mass (gr) of the elements in Solid phase divided by total mass of the suspension sample: total mass of the suspension sample was calculated based on the measured density and the total volume of the received sample; Mass of the elements in solid phase was calculated based on the mole fraction of each element in the compounds; PPC-M above sample physical properties (by ASTM C1603-05a, at 24° C.): pH=9.61; density=1.075 g/ml.

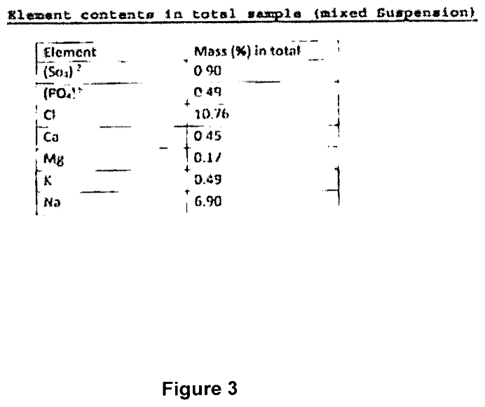

FIG. 4 depicts an example of a preferred PPC-E composition.

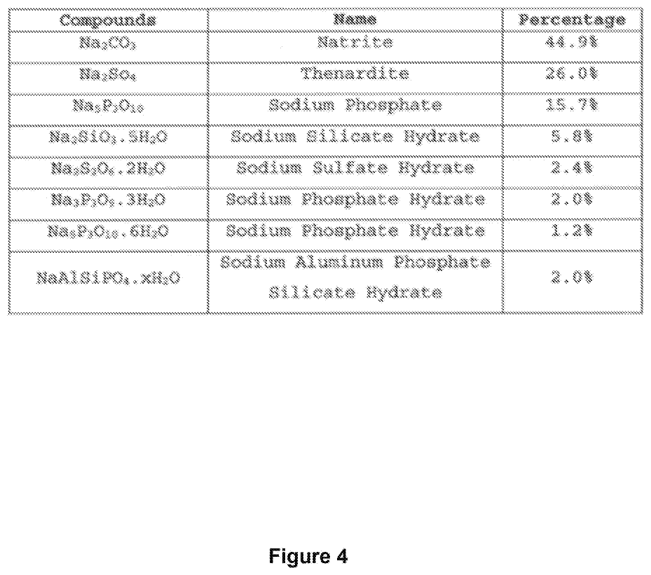

I claim:

1. A liquid chemical composition comprising
Dissolved Sulphate (SO₄) in a concentration range of 550 to 55000 milligrams per litre;
Dissolved Chloride (Cl) in a concentration range of 2200 to 220000 milligrams per litre;
Total Calcium (Ca) in a concentration range of 12 to 1200 milligrams per litre;
Total Magnesium (Mg) in a concentration range of 21 to 2100 milligrams per litre;
Total Potassium (K) in a concentration range of 39 to 3900 milligrams per litre;
Total Sodium (Na) in a concentration range of 1600 to 160000 milligrams per litre; and
Water (H₂O), Remaining balance.

2. A solid chemical composition comprising
NaCl (Halite) in a % weight range of 8.2 to 99.5;
KCl (Sylvite) in a % weight range of 0.4 to 40;
Ca₅(PO₄)₃(OH) (Hydroxylapatite) in a % weight range of 0.5 to 50;
K₂Ca₂Mg(SO₄)₄.2H₂O (Polyhalite) in a % weight range of 0.4 to 40;
MgSiO₃ (Magnesium Silicate) in a % weight range of 0.3 to 30;
SiO₂ (Silicon Oxide) in a % weight range of 0.2 to 20; and
SiO₂ (Quartz) in a % weight range of 0.1 to 10.

3. An aqueous suspension chemical composition comprising
(SO₄)²⁻ in a % weight range of 0.09 to 9;
(PO₄)³⁻ in a % weight range of 0.049 to 4.9;
Cl in a % weight range of 1.076 to 54;
Ca in a % weight range of 0.045 to 4.5;
Mg in a % weight range of 0.017 to 1.7;
K in a % weight range of 0.049 to 4.9;
Na in a % weight range of 0.69 to 69; and
Water (H₂O): Remaining balance

4. A solid mixture chemical composition comprising
Na₂C0₃ (Natrite) in a % weight range of 20-70;
Na₂SO₄ (Thernardite) in a % weight range of 2-50;
Na₅P₃O₁₀ (Sodium Phosphate) in a % weight range of 1-30;
Na₂SiO₃.5H₂O (Sodium Silicate Hydrate) in a % weight range of 0.5-11.5;
Na₂S₂O₆.2H₂O (Sodium Sulfate Hydrate) in a % weight range of 0.2-4.6;
Na₃P₃O₉.3H₂O (Sodium Phosphate Hydrate) in a % weight range of 0.1-4;
Na₅P₃O₁₀.6H₂O (Sodium Phosphate Hydrate) in a % weight range of 0.1-2.5;
NaAlSiPO₄.xH₂O (Sodium Aluminum Phosphate Silicate Hydrate) in a % weight range of 0.1-4.

5. The use of chemical compositions from any of claims 1 to 4 for the purposes described in the specification herein attached.

6. The use of mixtures and combinations of any chemical compositions from claims 1 to 4 for the purposes described in the specification herein attached.

7. The use of chemical compositions and mixtures from any of the previous claims, diluted with water to a ratio of solute:water between 1:0 and 1:1,000,000,000 (by weight or by volume), for the purposes described in the specification herein attached.
